(19) United States
(12) Patent Application Publication
(10) Pub. No.: US 2022/0333255 A1
(43) Pub. Date: Oct. 20, 2022

(54) A PROCESS FOR METHANATION

(71) Applicant: PHILLIPS 66 COMPANY, HOUSTON, TX (US)

(72) Inventors: Ying Liu, Bartlesville, OK (US); Samuel J. Baxter, Bartlesville, OK (US); Jianhua Yao, Bartlesville, OK (US)

(73) Assignee: PHILLIPS 66 COMPANY, HOUSTON, TX (US)

(21) Appl. No.: 17/724,929

(22) Filed: Apr. 20, 2022

Related U.S. Application Data
(60) Provisional application No. 63/176,935, filed on Apr. 20, 2021.

(51) Int. Cl. C25B 3/03; C25B 11/081

(52) U.S. Cl. CPC C25B 3/03; C25B 11/081

(57) ABSTRACT

A process for methanation comprising a first region for flowing a stream over a solid oxide electrolysis cell. In this first region the stream consists of CO₂, H₂, and H₂O, the stream is converted into a first conversion stream, and the solid oxide electrolysis cell is enhanced with a methanation catalyst. The process also has a removal region connected to the first region wherein the removal region is able to flow the first conversion stream away from the solid oxide electrolysis cell.

### CROSS-REFERENCE TO RELATED APPLICATIONS

This application is a non-provisional application which claims the benefit of and priority to U.S. Provisional Application Ser. No. 63/176,935 filed Apr. 20, 2021, entitled “A Process for Methanation,” which is hereby incorporated by reference in its entirety.

### STATEMENT REGARDING FEDERALLY SPONSORED RESEARCH OR DEVELOPMENT

None.

### FIELD OF THE INVENTION

This invention relates to a process for methanation.

### BACKGROUND OF THE INVENTION

Fossil fuels, such as coal, oil, and natural gas are non-renewable energy sources and their ever-increasing consumption leads to excessive emission of greenhouse gases, and in particular carbon dioxide (CO₂). To mitigate negative consequences of fossil fuel use, methods for reduction of carbon emission have been implemented, but with marginal success. Concern over fossil fuel use has also led to global development and implementation of renewable energy sources over the past decades. Renewable energy sources such as biomass are increasingly harvested to generate energy and raw materials (e.g., via gasification), but substantial technical issues remain due to low quality products and excess ash formation.

Conventionally, syngas is produced by coal gasification and hydrocarbon reforming. Syngas can be used as feedstock of many downstream processes such as Fischer-Tropsch process, methanation process for fuels, chemicals and high value hydrocarbons. However, all these processes require installation of expensive reactors.

Current technology for converting CO₂ and water to methane is a two-step, high pressure process wherein methane is not immediately generated. A typical two-step methane production process involves the following co-electrolysis and methanation reactions:

Co-Electrolysis

2H₂O→2H₂+O₂ (1)

2CO₂→2CO+O₂ (2)

Reverse Water Gas Shift

CO₂+H₂→CO+H₂O (3)

Methanation

CO₂+4H₂→CH₄+2H₂O (4)

CO+3H₂→CH₄+H₂O (5)

The first three reactions are related to the CO₂—H₂O co-electrolysis and take place in a solid oxide electrolysis cell (SOEC). The effluent is syngas. Reaction 4 and reaction 5 are methanation process which utilizes syngas produced from reactions 1-3 and reactions take place in a downstream methanation reactor with a methanation catalyst. There exists a need to perform the methanation step in a single process with high methane yield and selectivity.

### BRIEF SUMMARY OF THE DISCLOSURE

A process for methanation comprising a first region for flowing a stream over a solid oxide electrolysis cell. In this first region the stream consists of CO₂, H₂, and H₂O, the stream is converted into a first conversion stream, and the solid oxide electrolysis cell is enhanced with a methanation catalyst. The process also has a removal region connected to the first region wherein the removal region is able to flow the first conversion stream away from the solid oxide electrolysis cell.

A process for methanation comprising a first region for flowing a stream over a solid oxide electrolysis cell. In this first region the stream consists of CO₂, H₂, and H₂O, the stream is converted into a first conversion stream, and the solid oxide electrolysis cell is enhanced with a methanation catalyst. The process also has a second region connected to the first region wherein the second region is able to flow the first conversion stream from the first region into a secondary methanation catalyst. In this second region the first conversion stream is converted into a second conversion stream. Additionally, the process has a removal region connected to the second region wherein the removal region is able to flow the second conversion stream away from the solid oxide electrolysis cell and the secondary methanation catalyst.

In yet another embodiment, a process for methanation is taught where a first region flows a stream over a solid oxide electrolysis cell. In this first region the stream consists of CO₂, H₂, and H₂O, the stream is converted into a first conversion stream with a methane concentration greater than 10%, and the solid oxide electrolysis cell is enhanced with a methanation catalyst selected from a group 8, 9, or 10 metal. The process also has a second region connected to the first region wherein the second region is able to flow the first conversion stream from the first region into a secondary methanation catalyst. In this second region the first conversion stream is converted into a second conversion stream with a methane concentration greater than 20%. Additionally, the process has a removal region connected to the second region wherein the removal region is able to flow the second conversion stream away from the solid oxide electrolysis cell and the secondary methanation catalyst. Furthermore, this entire process occurs at ambient pressure and a temperature ranging from 350° C. to 550° C.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts an embodiment of the methanation in the tube.

FIG. 2 depicts an embodiment of the methanation in the tube.

FIG. 3 depicts an embodiment of the methanation in the tube.

FIG. 4 depicts CO₂ conversion and CH₄ selectivity of the methanation.

FIG. 5a depicts a scenario where there is no catalyst.

FIG. 5b depicts a scenario where a Ni catalyst paste is placed over the cathode.

FIG. 5C depicts a scenario where a Ni catalyst paste is placed over the cathode and a Ni catalyst is placed as a fixed bed in the effluent line.

FIG. 6 depicts activity under open circuit voltage conditions of FIG. 5A.

FIG. 7 depicts that CO₂ conversion to methane.

FIG. 8 depicts CO₂ conversion within an SOEC.

FIG. 9 depicts the open circuit voltage vs. applied voltage methanation data

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The following examples of certain embodiments of the invention are given. Each example is provided by way of explanation of the invention, one of many embodiments of the invention, and the following examples should not be read to limit, or define, the scope of the invention.

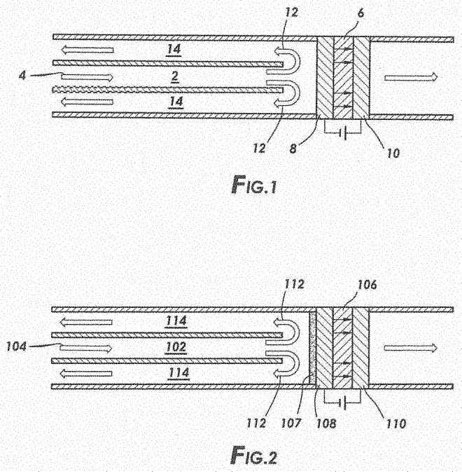

FIG. 1 depicts a solid oxide electrolysis cell (SOEC) for use in methanation. In this embodiment, a first region (2) is capable of flowing a stream (4) onto a SOEC device (6). The configuration of the device has cathode side (8) facing the stream and the anode side (10) facing away from the stream. After the stream contacts the SOEC device the stream is converted into a first conversion steam (12). The first conversion stream flows into the removal region (14) which is directed away from the SOEC device.

In one embodiment, the stream either comprises or consists essentially of CO₂, H₂ and H₂O. It is theorized that the electrolysis for CO₂ to produce syngas on the cathode side of the SOEC device and pure oxygen on the anode side of the SOEC device is an effective process. The syngas produced through this process can be converted to various products such as methane, methanol and liquid hydrocarbons, via existing technologies with additional process units.

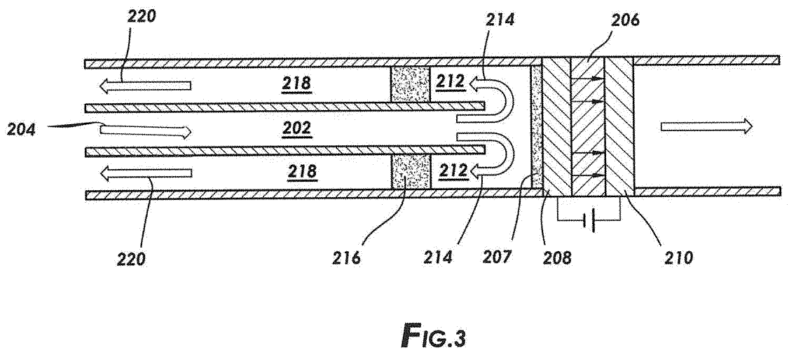

FIG. 2 depicts an alternate embodiment of a SOEC device for use in methanation. this embodiment, a first region (102) is capable of flowing a stream (104) onto a SOEC device (106) that is enhanced with a methanation catalyst (107). The configuration of the device has cathode side (108) facing the stream and the anode side (110) facing away from the stream. After the stream contacts the SOEC device the stream is converted into a first conversion steam (112). The first conversion stream flows into the removal region (114) which is directed away from the SOEC device. Although this figure depicts the methanation catalyst on the cathode side of the SOEC device different embodiments are possible. In one embodiment, the methanation catalyst can be impregnated into the SOEC cathode and in an alternate embodiment the methanation catalyst can be both impregnated into the SOEC cathode and placed on the outer side of the SOEC cathode.

It is also envisioned that in FIG. 2, the temperature of the process is not externally modified. When the temperature of the process is not externally modified it is expected that the temperature can range from about 350° C. to about 500° C. It is also envisioned that in FIG. 2, the pressure of the process is not externally modified. When the pressure of the process is not externally modified it is expected that the pressure can be from ambient pressure to about 60 bars.

The methanation catalyst chosen can be a group 8, 9, or 10 metal or some alloy or combination of a group 8, 9, or 10 metal. These metals can be ruthenium, osmium, hassium, indium, vanadium, cobalt, rhodium, iridium, meitnerium, nickel, palladium, and platinum. These metals can be distributed on the surface of various catalyst supports, such as Al₂O₃, SiO₂, SiO₂—Al₂O₃, TiO₂, ZrO₂.

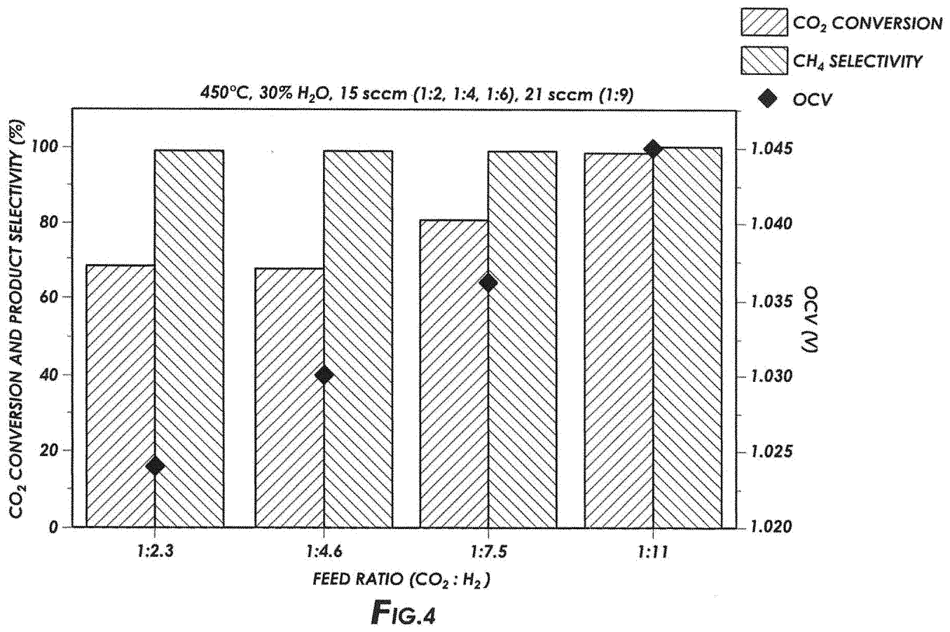

FIG. 3 depicts an alternate embodiment of a SOEC device for use in methanation. this embodiment, a first region (202) is capable of flowing a stream (204) onto a SOEC device (206) that is enhanced with a methanation catalyst (207). The configuration of the device has cathode side (208) facing the stream and the anode side (210) facing away from the stream. After the stream contacts the SOEC device the stream is converted into a first conversion steam (212). The first conversion stream flows into the second region (214) wherein the second region which is able to flow the first conversion stream into a secondary methanation catalyst (216). At the secondary methanation catalyst the first conversion stream is converted into a second conversion stream (218). The second conversion stream flows into the removal region (220) which is directed away from the SOEC device and the secondary methanation catalyst.

Although FIG. 3 depicts the methanation catalyst on the cathode side of the SOEC device different embodiments are possible. In one embodiment, the methanation catalyst can be impregnated into the SOEC cathode and in an alternate embodiment the methanation catalyst can be both impregnated into the SOEC cathode and placed on the outer side of the SOEC cathode.

Although FIG. 3 depicts the methanation catalyst packed in the middle section of the tube, it can be located anywhere else downstream and it can be applied to the inner surface of the tube by various methods such as slurry coating, painting, and dip coating.

FIG. 3 depicts the secondary methanation catalyst and the methanation catalyst as two separate catalysts however in the material composition can be identical in some embodiments or different in some embodiments. In some embodiments both the methanation catalyst and the secondary methanation catalyst can be independently selected from the group 8, 9, or 10 metals or some alloy or combination of a group 8, 9, or 10 metals. These metals can be ruthenium, osmium, hassium, indium, vanadium, cobalt, rhodium, iridium, meitnerium, nickel, palladium, and platinum. These metals can be distributed on the surface of various catalyst supports, such as Al₂O₃, SiO₂, SiO₂—Al₂O₃, TiO₂, ZrO₂.

In FIG. 1, FIG. 2, and FIG. 3, each embodiment depicted the process of methanation in a tube. In some embodiments the process occurs in a plurality of tubes. In other embodiments, the process can be in a planar system.

### EXAMPLE

### Example 1

A SOEC comprises of three functional layers: a porous Ni—YSZ cathode support, dense YSZ electrolyte membrane, and a porous Sm_{0.5}Sr_{0.5}CoO₃ (SSC)—Gd_{0.1}Ce_{0.9}O₃ (GDC) anode. The feed gas mixture consisted of 11.9% CO₂, 71.4% H₂ and 16.7% steam with a total flow rate of 75.6 cc/min. The experiments were carried out at ambient pressure, a fixed temperature of 450° C. and an applied voltage of 2.0 V. It is expected that the pressure, temperature, and applied voltage can all vary depending on the conditions and material used for the cathode and the catalyst. The test results of all three process configurations are shown in Table 1. In configuration 1, syngas was supposed to be the only reaction product and no methane should be detected in the effluent. However, the cathode of the SOEC contained 60 wt. % nickel, which itself was an excellent methanation catalyst. As a result, 9.39 vol % methane was measured in the effluent. When an additional thin layer of Ni catalyst (methanation catalyst) was applied onto the surface of SOEC cathode (configuration 2), Methane concentration in the process effluent increased to 17.4 vol %. Methane yield further increased to 26.38 vol % in configuration 3, where a Ni catalyst layer was applied on cathode surface and 2 grams of Ni catalyst was placed downstream of the SOEC.

TABLE 1

| | Methane concentration | Possible methane concentrations |
|---|---|---|
| Process Configuration | in process effluent, vol % | in process effluent, vol % |
| (1) SOEC alone | 9.39 | less than 10 |
| (2) SOEC + Ni catalyst on cathode | 17.40 | greater than 10, greater than 17, |
| | | greater than 20 |
| (3) SOEC + Ni catalyst on cathode + | 26.38 | greater than 20, greater than 25, |
| Ni catalyst downstream of the cathode | | greater than 30 |

FIG. 4 depicts methanation data that shows that both methanation and CO₂ conversion can reach 100% based upon the initial ratio of CO₂ and H₂ that enters into the tube. In this example the pressure was kept at ambient pressure, the temperature was constant at 450° C. and the only variable is the ratio of CO₂:H₂ which flowed at a rate of 15 sccm.

### Example 2

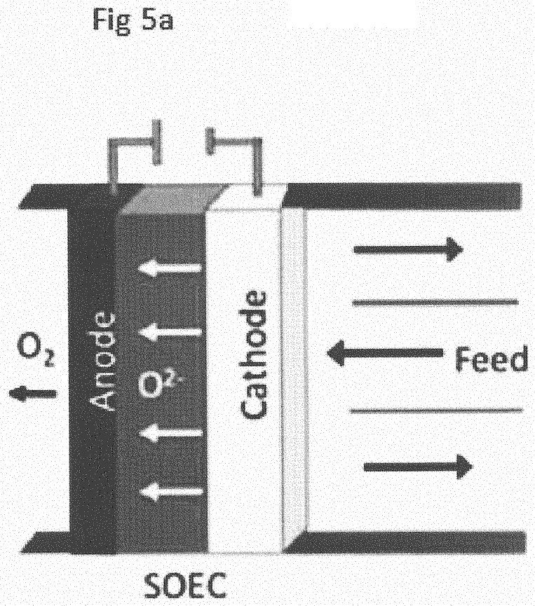

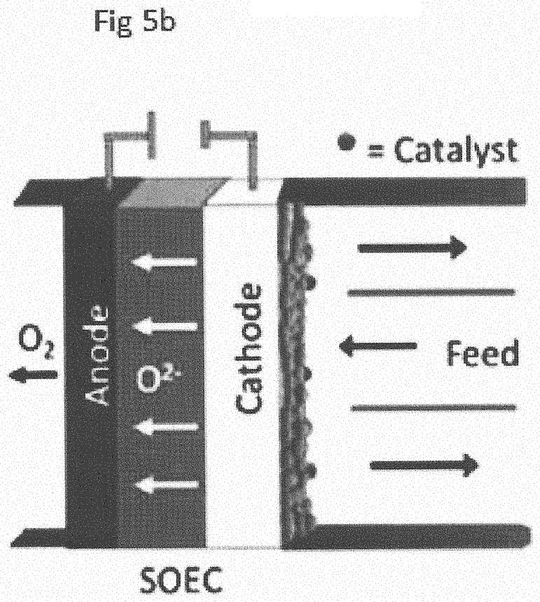

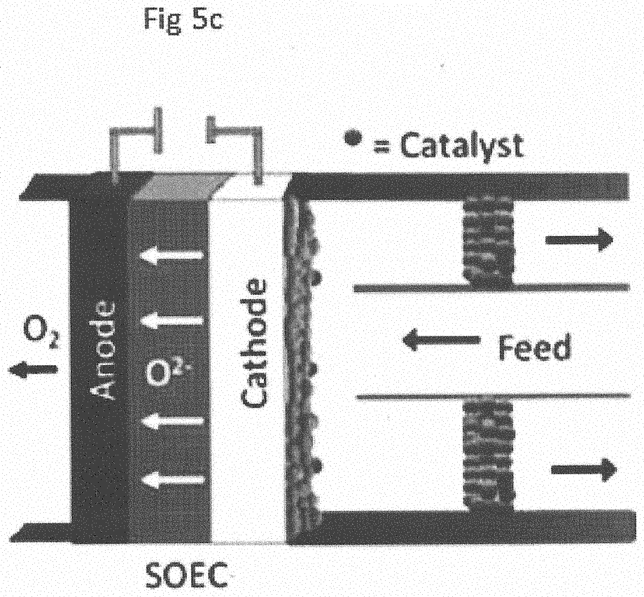

In this example three different scenarios were implemented as shown in FIGS. 5a, FIG. 5b, and FIG. 5c. FIG. 5a depicts a scenario where there is no catalyst, FIG. 5b depicts a scenario where a Ni catalyst paste is placed over the cathode, and FIG. 5C depicts a scenario where a Ni catalyst paste is placed over the cathode and a Ni catalyst is placed as a fixed bed in the effluent line.

In FIG. 5a, a small but significant amount of methane can be generated (16% CO₂ conversion, 72% methane selectivity) at 450° C. without any catalyst implementation necessary. This is a known phenomenon in which reduced nickel over the SOEC cathode (formed from NiO precursor) can still facilitate both the methanation and reverse water-gas shift reactions even though it has a significantly smaller surface area compared to methanation catalysts which are typically disposed over high surface area supports such as γ-Al₂O₃. The high mass percentage of the nickel oxide in the active cathodic layer (˜60 wt %) leads to significantly higher Ni content upon reduction than that of typical methanation catalysts. This higher Ni content can cause increased sintering and the formation of larger particles than are present over methanation catalysts which typically contain under 20 wt % of the active catalytic metal to avoid rapid sintering.

In FIG. 5B, the methanation catalyst was applied as a paste over the cathode surface. The final dried layer was analyzed via scanning electron microscopy (SEM) and was shown to be roughly equivalent in thickness to the anode layer. The applied catalyst paste (˜0.1 g) over the SOEC cathode afforded roughly 44% CO₂ conversion with a slightly higher CH₄ selectivity of 74%, indicating the substantial activity of the commercial methanation catalyst even when applied as a thin paste. The long-term implications of this interface between methanation catalyst and ceramic electrode is still unclear, however there was no evidence of activity loss or obvious degradation observed after cell conditioning at 650° C. for 48 h and ˜48 h of cell testing above 450° C.

In FIG. 5C, both a catalyst paste and effluent bed were utilized for methanation. In this final configuration, a CO₂ conversion of 70.5% was achieved with a CH₄ selectivity of 99.6%. The drastically higher selectivity of FIG. 5C likely derived from the reduced gas hourly space velocity (GHSV) as the sample went from roughly 0.1 g of catalyst paste to 2.1 g of catalyst paste plus catalyst bed. This reduced the overall GHSV from 5670 h⁻¹ to 857 h⁻¹.

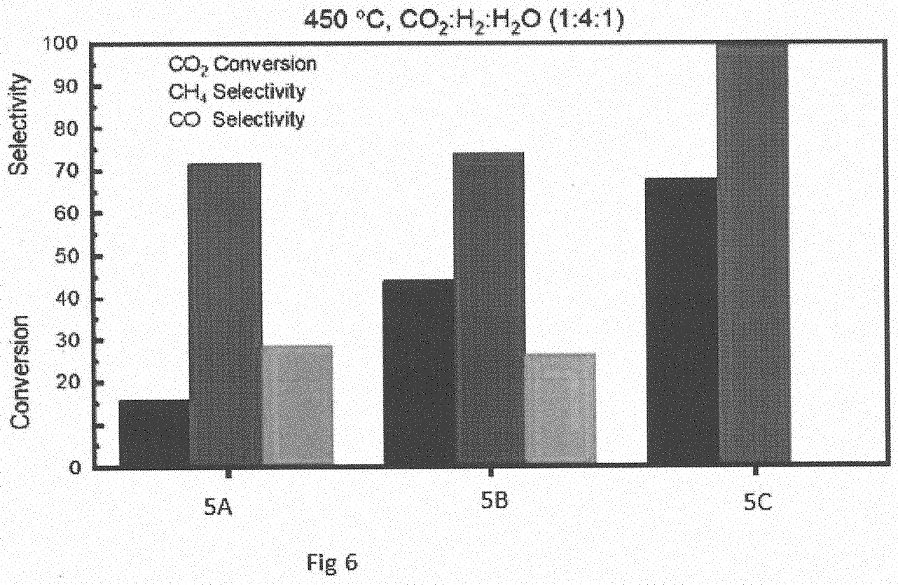

FIG. 6 depicts activity under open circuit voltage conditions of FIG. 5A, FIG. 5B, and FIG. 5C scenarios.

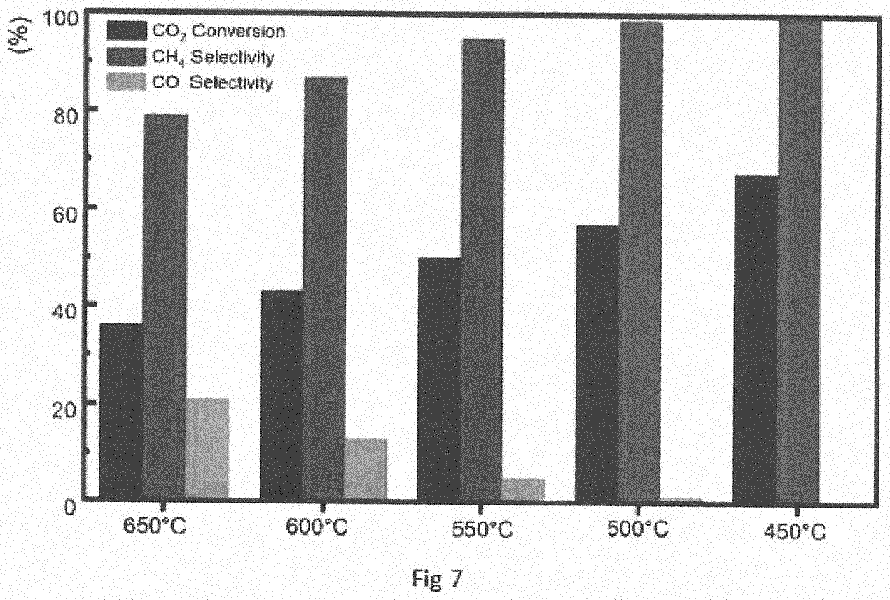

FIG. 7 depicts that CO₂ conversion to methane at CO₂:H₂:H₂O=1:4:1 is inversely proportional to temperature over the measured temperature range, correlating strongly that methanation catalyst activity becomes thermodynamically unfavored at higher temperatures.

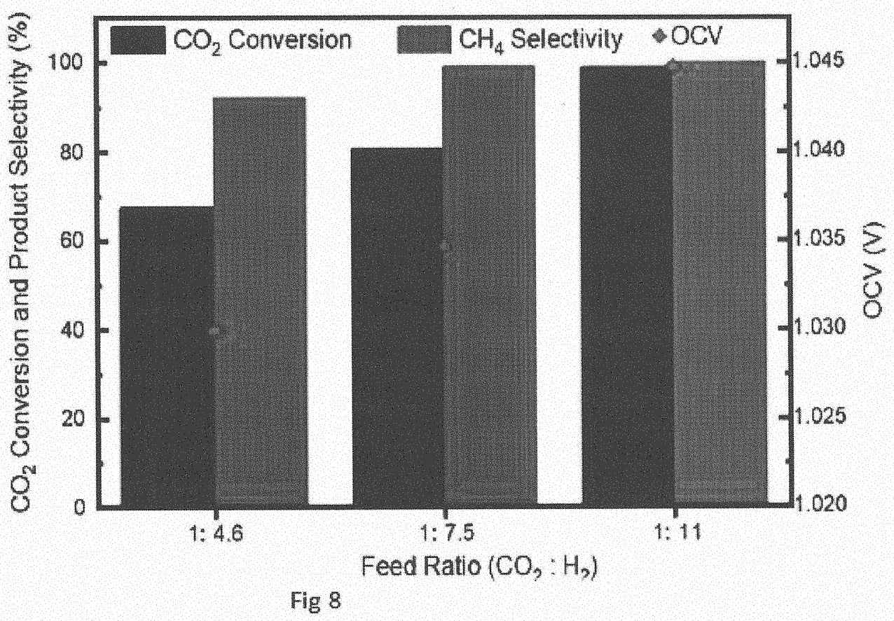

FIG. 8 depicts CO₂ conversion within an SOEC, although near 100% CO₂ conversion and CH₄ selectivity was not achieved until a ratio of roughly 11:1 H₂:CO₂ (CO₂ conversion=98.9%, CH₄ selectivity=99.7%).

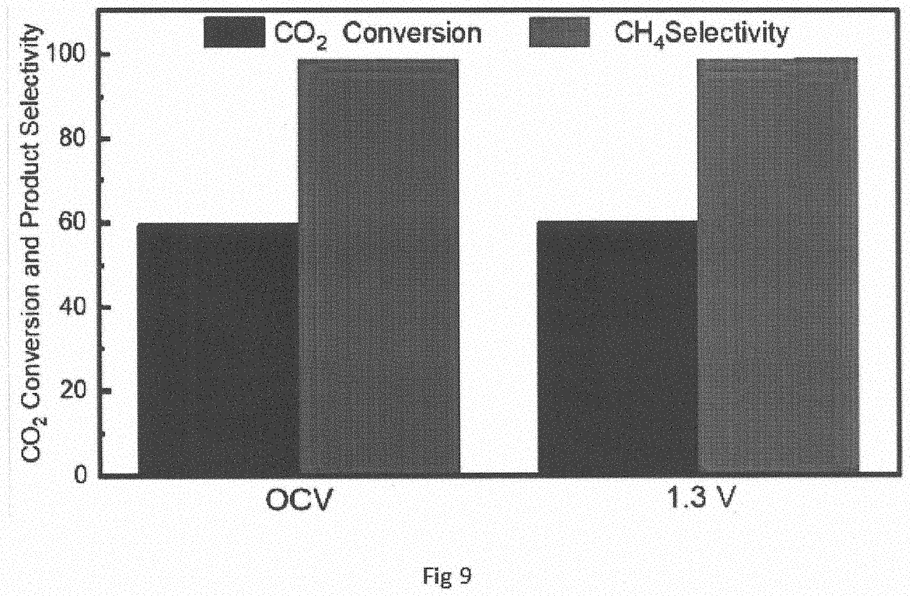

FIG. 9 depicts the open circuit voltage (OCV) vs. applied voltage methanation data for a YSZ cell held at 450° C. and a 1:4:1 feed ratio (CO₂:H₂:H₂O) at 25 sccm total flow rate. The current density achieved under 1.3 V was 14 mA/cm2.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for methanation comprising:
a first region for flowing a stream over a solid oxide electrolysis cell,
wherein the stream consists of: CO₂, H₂, and H₂O,
wherein the stream is converted into a first conversion stream, and
wherein the solid oxide electrolysis cell is enhanced with a methanation catalyst; and
a removal region connected to the first region wherein the removal region is able to flow the first conversion stream away from the solid oxide electrolysis cell.

2. The process of claim 1, wherein the temperature in the process is not externally modified.

3. The process of claim 1, wherein the pressure in the process is not externally modified.

4. The process of claim 1, wherein the first conversion stream has a methane concentration greater than 10%.

5. The process of claim 1, wherein the stream has a methane concentration less than 1%.

6. The process of claim 1, wherein the methanation catalyst is selected from a group 8, 9, or 10 metal.

7. The process of claim 1, wherein the methanation catalyst is a nickel metallic catalyst or a ruthenium metallic catalyst with or without a catalyst support

8. The process of claim 1, wherein the metallic catalyst is on the outside surface of the solid oxide electrolysis cell.

9. The process of claim 1, wherein the methanation catalyst is intermixed with the cathode of the solid oxide electrolysis cell.

10. A process for methanation comprising:
a first region for flowing a stream over a solid oxide electrolysis cell,
wherein the stream consists of: CO₂, H₂, and H₂O,
wherein the stream is converted into a first conversion stream, and
wherein the solid oxide electrolysis cell is enhanced with a methanation catalyst;
a second region connected to the first region wherein the second region is able to flow the first conversion steam from the first region into a secondary methanation catalyst,
wherein the first conversion stream is converted into a second conversion stream; and
a removal region connected to the second region wherein the removal region is able to flow the second conversion stream away from the solid oxide electrolysis cell and the secondary methanation catalyst.

11. The process of claim 10, wherein the temperature in the process is not externally modified.

12. The process of claim 10, wherein the pressure in the process is not externally modified.

13. The process of claim 10, wherein the first conversion stream has a methane concentration greater than 10%.

14. The process of claim 10, wherein the stream has a methane concentration less than 1%.

15. The process of claim 10, wherein the second conversion stream has a methane concentration greater than 20%.

16. The process of claim 10, wherein the metallic catalyst is selected from a group 8, 9, or 10 metal in metallic form or supported metallic form

17. The process of claim 10, wherein the metallic catalyst is a nickel metallic catalyst or a ruthenium metallic catalyst with or without a catalyst support.

18. The process of claim 10, wherein the metallic catalyst is on the outside surface of the solid oxide electrolysis cell.

19. The process of claim 10, wherein the metallic catalyst is intermixed with the cathode of the solid oxide electrochemical cell.

20. A process for methanation comprising:
a first region for flowing a stream over a solid oxide electrolysis cell,
wherein the stream consists essentially of: CO₂, H₂, and H₂O,
wherein the stream is converted into a first conversion stream with a methane concentration greater than 10%, and
wherein the solid oxide electrochemical cell is enhanced with a methanation catalyst selected from a group 8, 9, or 10 metal;
a second region connected to the first region wherein the second region is able to flow the first conversion steam from the first region into a secondary methanation catalyst,
wherein the first conversion stream is converted into a second conversion steam with a methane concentration greater than 20%; and
a removal region for directing the first conversion stream away from the solid oxide electrolysis cell and the secondary methanation catalyst
wherein the process occurs at ambient pressure and a temperature ranging from 350° C. to 550° C.
